(19) United States
(12) Patent Application Publication
(10) Pub. No.: US 2012/0074718 A1
(43) Pub. Date: Mar. 29, 2012

(54) DOOR OUTER HANDLE DEVICE FOR VEHICLE

(75) Inventors: Koichi NAGATA, Chiryu-shi (JP); Nobukazu Araki, Hekinan-shi (JP)

(73) Assignee: AISIN SEIKI KABUSHIKI KAISHA, Kariya-shi (JP)

(21) Appl. No.: 13/204,873

(22) Filed: Aug. 8, 2011

(30) Foreign Application Priority Data
Sep. 28, 2010 (JP) 2010-216879
Jun. 28, 2011 (JP) 2011-142828

(51) Int. Cl. E05B 3/00

(52) U.S. Cl. 292/336.3

(57) ABSTRACT

A door outer handle device for a vehicle includes a base member, an outer handle, a link mechanism, and a door opening prevention mechanism restricting a component member of the link mechanism from moving in a door opening direction by a predetermined inertia force. The door opening prevention mechanism includes a lever member being rotatable to a set rotation position to restrict the component member from moving in the door opening direction. The lever member is rotatable to a retracted rotation position to allow the component member to move in the door opening direction by being shifted to the retracted rotation position in an early stage of an operation of the outer handle from the door closed position to the door open position while the inertia force is not being applied. The door opening prevention mechanism further includes a biasing member biasing the lever member to the retracted rotation position.

### CROSS REFERENCE TO RELATED APPLICATIONS

This application is based on and claims priority under 35 U.S.C. §119 to Japanese Patent Application 2010-216879, filed on Sep. 28, 2010, and Japanese Patent Application 2011-142828, filed on Jun. 28, 2011, the entire contents of which are incorporated herein by reference.

### TECHNICAL FIELD

This disclosure generally relates to a door outer handle device for a vehicle.

### BACKGROUND DISCUSSION

A known door outer handle device for a vehicle includes a base member fixed to a door for the vehicle, an outer handle, a link mechanism, and a door opening prevention mechanism. The outer handle is attached to the base member in a movable manner in inward and outward directions of the vehicle (i.e., vehicle inward and outward directions) so as to be operable between a door closed position and a door open position. The link mechanism transmits a door opening operation of the outer handle as an unlatched operation of a door latch mechanism. The door opening prevention mechanism restricts an operation of a component member of the link mechanism in a door opening direction by a predetermined inertia force applied to the door in the vehicle outer direction in a case of a vehicle collision (i.e., the door opening prevention mechanism invalidates a function of the link mechanism).

In the event of the vehicle collision, the component member of the link mechanism operates in the door opening direction because the outer handle is opened by the predetermined inertia force applied to the door in the vehicle outward direction at a time of the vehicle collision. The unlatched operation of the door latch mechanism is an operation to bring the door latch mechanism in a latched state to an unlatched state. In the latched state of the door latch mechanism, it is impossible to open the door of the vehicle when in a closed state. In the unlatched state of the door latch mechanism, it is possible to open the door of the vehicle when in the closed state.

The aforementioned door outer handle device is disclosed in JP2009-243101A (which will be hereinafter referred to as Reference 1), for example. According to Reference 1, the door opening prevention mechanism includes an inertia stopper member (a lever member) and a biasing member. The inertia stopper member is provided at the base member so as to be rotatable from a set rotation position (i.e., an initial position) to a locked rotation position in the vehicle outer direction. The biasing member biases the inertia stopper member to the set rotation position. According to the door outer handle device disclosed in Reference 1, an inertia force generated upon a vehicle collision is applied to the inertia stopper member so that the inertia stopper member rotates from the set rotation position to the locked rotation position in the vehicle outward direction against a biasing force of the biasing member. At this time, a portion of the inertia stopper member moves within a door opening direction movement locus of the component member of the link mechanism. As a result, the link mechanism is restricted from moving in the door opening direction by the inertia stopper member.

According to the door outer handle device disclosed in Reference 1, in a case where the inertia stopper member is maintained at the set rotation position by the biasing force of the biasing member, the inertia stopper member is positioned out of the door opening direction movement locus, thereby allowing the link mechanism to operate in the door opening direction. The door for the vehicle is thus opened by the door opening operation of the outer handle.

In the door outer handle device disclosed in Reference 1, before the outer handle is opened by the predetermined inertia force applied in the door outward direction in the event of the vehicle collision, the predetermined inertia force is applied to the inertia stopper member. Then, the inertia stopper member rotates from the set rotation position to the locked rotation position in the vehicle outward direction against the biasing force of the biasing member. As a result, the portion of the inertia stopper member moves within the door opening direction movement locus of the component member from an outside thereof.

Therefore, as long as the inertia stopper member appropriately or normally rotates in the event of the vehicle collision, a certain operation is obtained by the door opening prevention mechanism. However, in a case where the inertia stopper member does not appropriately rotate and thus an operation responsiveness of the inertia stopper member in the door outer direction by the inertia force is insufficient, the component member of the link mechanism may not be restricted from operating in the door opening direction by the inertia stopper member. Consequently, the unlatched operation of the door latch mechanism may not be securely prevented.

In addition, according to the door outer handle device disclosed in Reference 1, the inertia stopper member is normally held at the set rotation position (i.e., the initial position) by the biasing force of the biasing member. The inertia stopper member is configured so as not to rotate by a normal operation of the outer handle (i.e., a normal door opening operation). Thus, dirt or dust may be attached and solidified at a rotation portion of the inertia stopper member. As a result, a rotation of the inertia stopper member may not be guaranteed for a long period of time, which may prevent a predetermined rotation of the inertia stopper member at a time of a possible vehicle collision.

A need thus exists for a door outer handle device for a vehicle which is not susceptible to the drawback mentioned above.

### SUMMARY

According to an aspect of this disclosure, a door outer handle device for a vehicle includes a base member configured to be fixed to a door for the vehicle, an outer handle attached to the base member in a movable manner in vehicle inner and outer directions, the outer handle being operable between a door closed position and a door open position, the door open position being arranged in the vehicle outer direction relative to the door closed position, a link mechanism configured to transmit a door opening operation of the outer handle as an unlatched operation of a door latch mechanism, and a door opening prevention mechanism restricting a component member of the link mechanism from moving in a door opening direction by a predetermined inertia force applied to the door in the vehicle outer direction. The door opening prevention mechanism includes a lever member being rotatable to a set rotation position where the lever member is held at the base member to restrict the component member of the link mechanism from moving in the door opening direction in a case where the outer handle is arranged at the door closed position. The lever member is rotatable to a retracted rotation position that is positioned at least in the vehicle inner direction from the set rotation position. The lever member is shifted to the retracted rotation position in an early stage of an operation of the outer handle from the door closed position to the door open position in a case where the outer handle is operated from the door closed position to the door open position in a state where the inertia force is prevented from being applied. The lever member allows the component member of the link mechanism to move in the door opening direction when the lever member is arranged at the retracted rotation position. The door opening prevention mechanism further includes a biasing member biasing the lever member to the retracted rotation position.

According to another aspect of this disclosure, a door outer handle device for a vehicle includes a base member configured to be fixed to a door for the vehicle, an outer handle attached to the base member in a movable manner in vehicle inner and outer directions, the outer handle being operable between a door closed position and a door open position, the door open position being arranged in the vehicle outer direction relative to the door closed position, a link mechanism configured to transmit a door opening operation of the outer handle as an unlatched operation of a door latch mechanism, and a door opening prevention mechanism restricting a component member of the link mechanism from moving in a door opening direction by a predetermined inertia force applied to the door in the vehicle outer direction. The door opening prevention mechanism includes a lever member being rotatable to a set rotation position where the lever member is held at the base member to restrict the component member of the link mechanism from moving in the door opening direction in a case where the outer handle is arranged at the door closed position in a state where the inertia force is prevented from being applied The lever member is rotatable to a retracted rotation position that is positioned at least in the vehicle inner direction from the set rotation position. The lever member is shifted to the retracted rotation position in an early stage of an operation of the outer handle from the door closed position to the door open position in a case where the outer handle is operated from the door closed position to the door open position in a state where the inertia force is prevented from being applied. The lever member allows the component member of the link mechanism to move in the door opening direction when the lever member is arranged at the retracted rotation position. The lever member is rotatable to a locked rotation position that is positioned at least in the vehicle outer direction from the set rotation position. The lever member is shifted to the locked rotation position to restrict the component member of the link mechanism from moving in the door opening direction in a state where the inertia force is applied. The door opening prevention mechanism further includes a biasing member biasing the lever member to the retracted rotation position.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a partial perspective view of a door for a vehicle including a door outer handle device for the vehicle when viewed from an outer side of the vehicle according to a first embodiment disclosed here;

FIG. 2 is plan view of a main structure of the door outer handle device illustrated in FIG. 1 when the main structure is in a set state;

FIG. 3 is a diagram of the main structure of the door outer handle device when viewed from an inner direction of the door;

FIG. 4 is a diagram of the main structure of the door outer handle device when viewed from a right side in FIG. 3 (i.e., a rear side of the vehicle);

FIG. 5 is a perspective view of the main structure of the door outer handle device illustrated in FIGS. 3 and 4 when viewed from a vehicle rear direction at a door inner side;

FIG. 6 is a perspective view of the main structure of the door outer handle device illustrated in FIGS. 3 and 4 when viewed from a vehicle front direction at the door inner side;

FIG. 7 is a longitudinal sectional front view illustrating a relationship among a base member, a lever member, and a spring disposed between the base member and the lever member in a state illustrated in FIGS. 2 to 6 (i.e., in the set state);

FIG. 8 is a plan view illustrating a relationship among the base member, the lever member, and an outer handle in the state illustrated in FIGS. 2 to 6 (i.e., in the set state);

FIG. 9 is cross sectional view taken along the line IX-IX in FIG. 8;

FIG. 10 is a perspective view of the base member illustrated in FIGS. 2 to 9 when viewed from the vehicle rear direction at the door inner side;

FIG. 11 is a perspective view of the base member illustrated in FIGS. 2 to 9 when viewed from the vehicle front direction at the door inner side;

FIG. 12 is a front view of the lever member illustrated in FIGS. 2 to 9;

FIG. 13 is a plan view of the lever member illustrated in FIG. 12;

FIG. 14 is a longitudinal sectional end view taken along the line XIV-XIV in FIG. 12;

FIG. 15 is a perspective view of the main structure of the door outer handle device when viewed from the vehicle rear direction at the door inner side in a case where the lever member illustrated in FIG. 5 is positioned at a retracted rotation position (i.e., in a retracted state);

FIG. 16 is a perspective view of the main structure of the door outer handle device when viewed from the vehicle front direction at the door inner side in a case where the lever member illustrated in FIG. 5 is positioned at a retracted rotation position (i.e., in the retracted state);

FIG. 17 is a plan view illustrating a relationship among the base member, the lever member, and the outer handle in a state illustrated in FIGS. 15 and 16 (i.e., in the retracted state);

FIG. 18 is a perspective view of the main structure of the door outer handle device when viewed from the vehicle rear direction at the door inner side in a case where the lever member illustrated in FIG. 5 is in a locked rotation position (i.e., in a locked state; at a time of a vehicle collision where a predetermined inertia force is applied in the vehicle outer direction to the lever member);

FIG. 19 is a perspective view of the main structure of the door outer handle device when viewed from the vehicle front direction at the door inner side in a case where the lever member illustrated in FIG. 6 is in the locked rotation position;

FIG. 20 is a diagram of the main structure illustrated in FIGS. 18 and 19 when viewed from the door inner side;

FIG. 21 is a longitudinal sectional front view illustrating a relationship among the base member, the lever member, and the spring disposed between the base member and the lever member in a state illustrated in FIGS. 18 to 20 (i.e., in the locked state);

FIG. 22 is a plan view illustrating a relationship among the base member, the lever member, and the outer handle in a state illustrated in FIGS. 18 to 21 (i.e., in the locked state);

FIG. 23 is a perspective view of a main structure of a door outer handle device for a vehicle when viewed from a vehicle rear direction at a door inner side according to a second embodiment disclosed here;

FIG. 24 is a perspective view illustrating a state where a lever member and a coil spring are assembled on a case illustrated in FIG. 23 (i.e., the case, the lever member, the coil spring, and the liker are sub-assembled);

FIG. 25 is an exploded perspective view of the case, the lever member, and the coil spring illustrated in FIG. 24;

FIG. 26 is a perspective view of the case illustrated in FIG. 25;

FIG. 27 is a side view of the case illustrated in FIG. 26 when viewed from a door outer side;

FIG. 28 is a side view of the lever member illustrated in FIG. 25 when viewed from the door outer side;

FIG. 29 is a plan view of the lever member illustrated in FIG. 28;

FIG. 30 is an operation explanatory view illustrating the set state of the main structure of the door outer handle device illustrated in FIG. 23;

FIG. 31 is a cross-sectional view illustrating a relationship among the case, the lever member, the coil spring, and the like in the state illustrated in FIG. 30;

FIG. 32 is an operation explanatory view of the main structure in the event of a vehicle collision (i.e., in a state where the lever member is held at the locked rotation position);

FIG. 33 is an operation explanatory view of the main structure after the vehicle collision (i.e., in a state where a connection lever is returned after the vehicle collision); and

FIG. 34 is a cross-sectional view illustrating the relationship among the case, the lever member, and the coil spring in the state illustrated in FIGS. 32 and 33.

### DETAILED DESCRIPTION

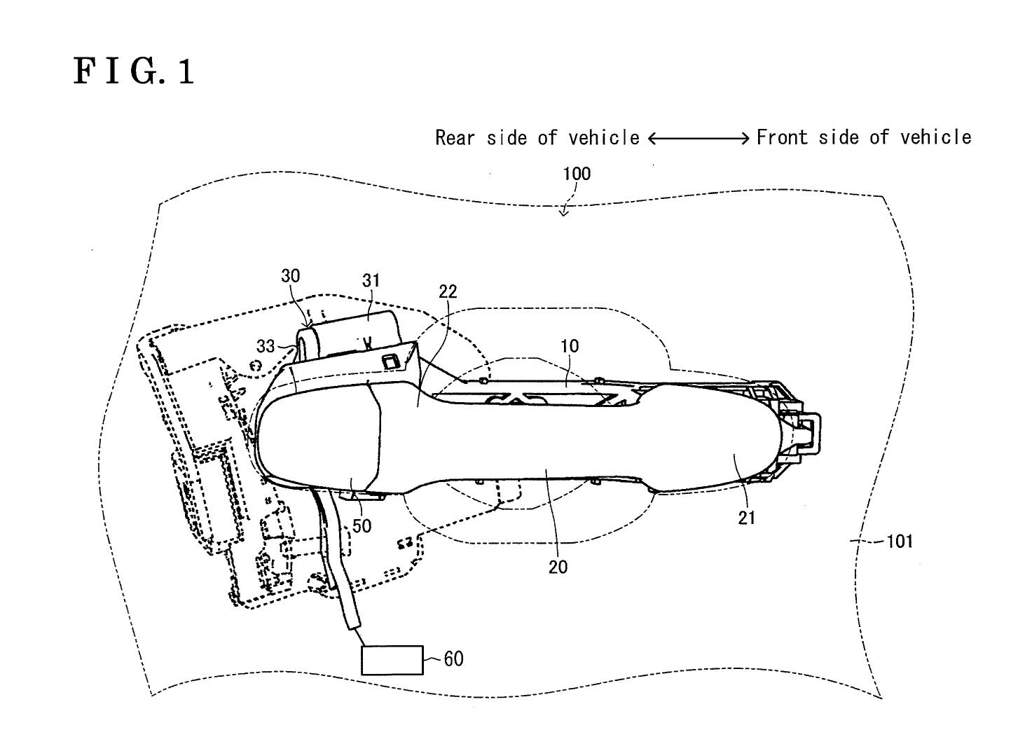

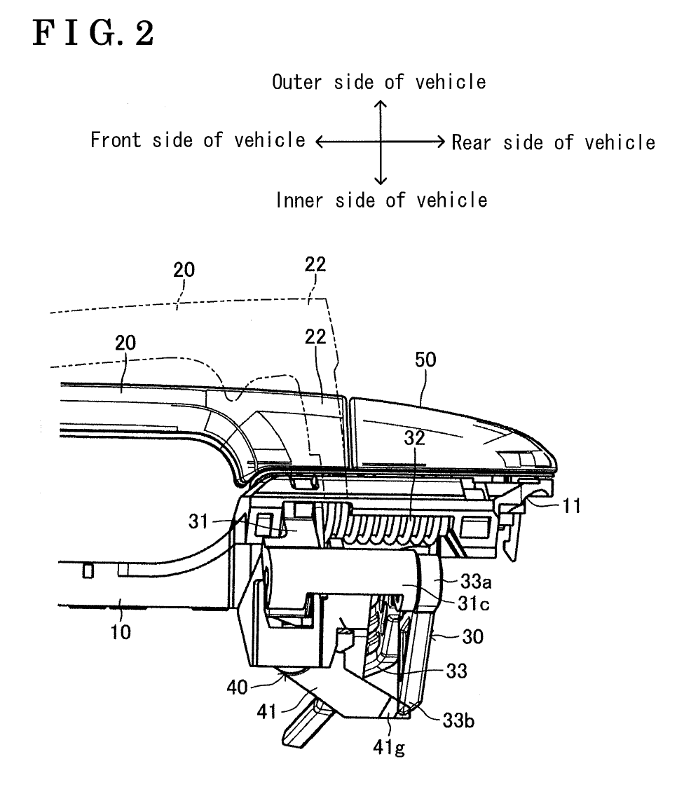

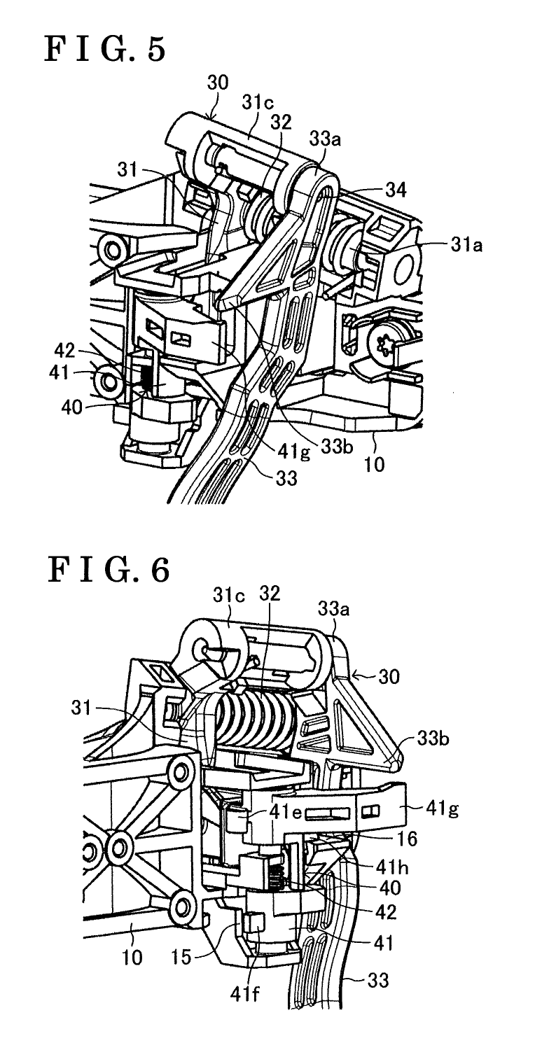

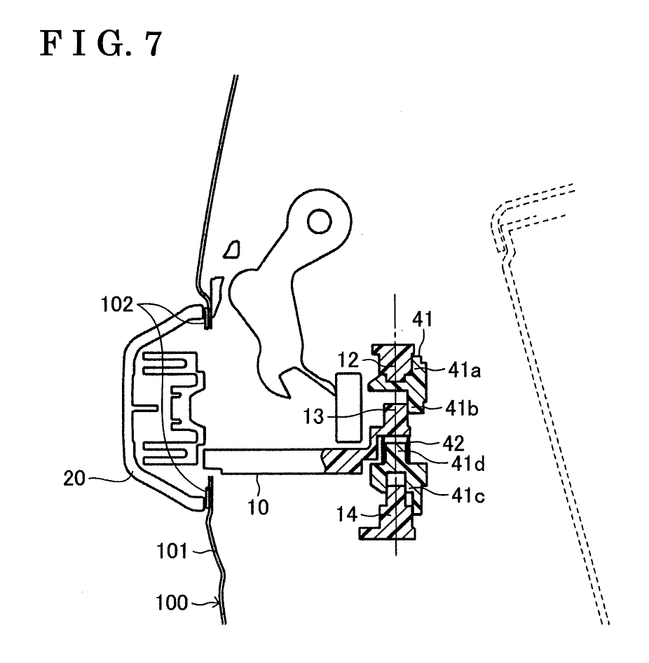

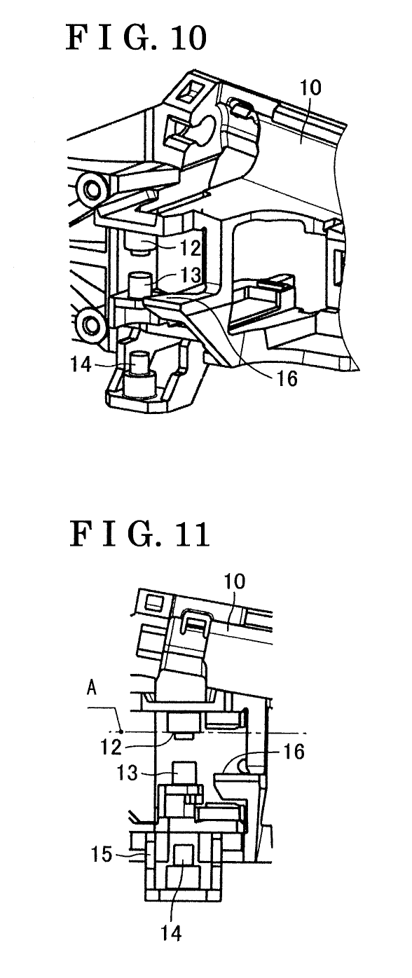

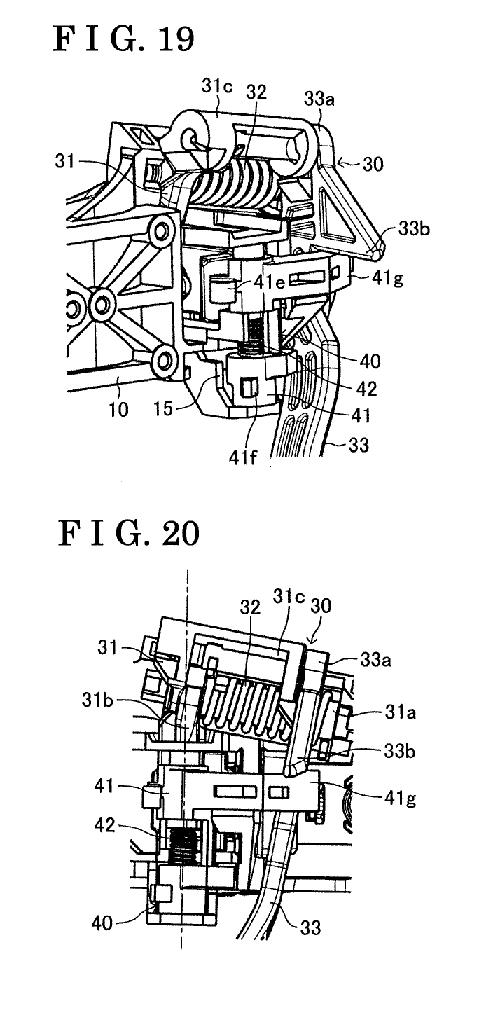

A first embodiment will be explained with reference to FIGS. 1 to 22. FIG. 1 illustrates a door for a vehicle including a door outer handle device for the vehicle according to the first embodiment. In the embodiment, directions and orientations such as left, right, front, rear, top, and bottom correspond to those of the vehicle at which the door outer handle device is mounted. In FIG. 1, a base member 10 is fixed to a door 100 mounted at a right rear side of the vehicle. As illustrated in FIG. 2, an outer handle 20, a link mechanism 30, a door opening prevention mechanism 40, and the like are mounted on the base member 10. The base member 10 is fixed to an inner side of an outer panel 101 at the door 100 (see FIG. 7). As illustrated in FIGS. 1 and 2, a cap 50 is mounted on a rear end portion 11 of the base member 10 while sandwiching the outer panel 101 (which is omitted in FIG. 2) relative to the rear end portion 11 so as to restrain the outer handle 20 from disengaging from the base member 10.

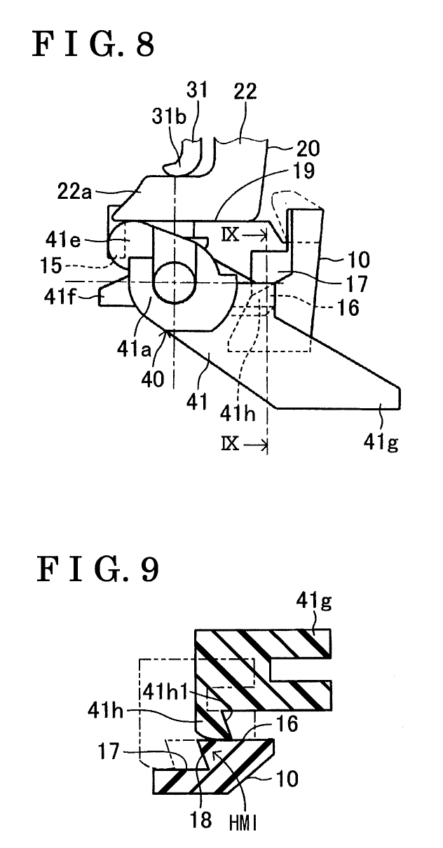

The outer handle 20 is a grip type handle mounted on the base member 10 and is substantially horizontally arranged so as to be rotatable in inner and outer directions of the vehicle (i.e., a vehicle width direction) (which will be hereinafter referred to as vehicle inner and outer directions). The outer handle 20 is assembled on the base member 10 so that the outer panel 101 is sandwiched between the outer handle 20 and the base member 10. The outer handle 20 is operable between a door closed position (illustrated by a solid line in FIG. 2) and a door open position (illustrated by an imaginary line in FIG. 2). The door open position is arranged in the vehicle outer direction relative to the door closed position. The outer handle 20 includes a front end portion 21 at which the outer handle 20 is rotatably mounted on the base member 10 and includes a rear end portion 22 being movable by a predetermined amount in the vehicle outer direction from a position illustrated by the solid line (i.e., the door closed position) to a position illustrated by the imaginary line (i.e., the door open position) in FIG. 2. An engagement portion 22a (see FIG. 8) having substantially an L-shape is formed at the rear end portion 22 of the outer handle 20. The engagement portion 22a, which serves as a third engagement portion, is engageable with a bell crank 31 serving as a component member of the link mechanism 30 and a lever member 41 serving as a component member of the door opening prevention mechanism 40. In a case where the outer handle 20 is in the door closed position, upper and lower ends of the outer handle 20 are in contact or engagement with the outer panel 101 via respective cushions 102 as illustrated in FIG. 7. In the case where the outer handle 20 is in the door closed position, the engagement portion 22a may be in contact or engagement with a stopper portion 19 formed at the base member 10 as illustrated in FIG. 8.

The link mechanism 30 transmits a door opening operation of the outer handle 20 in the vehicle outer direction as an unlatched operation of a door latch mechanism 60 (i.e., an operation to shift the door latch mechanism 60 from a latched state to an unlatched state). As illustrated in FIGS. 2 to 6, the link mechanism 30 includes a coil spring 32 and a connection lever 33 in addition to the bell crank 31. The door latch mechanism 60 according to the present embodiment has a known structure including a striker fixed to a vehicle body, a latch and a pawl mounted on the door 100, and the like. In the latched state of the door latch mechanism 60, the pawl restricts a rotation of the latch that engages with the striker to thereby prohibit the door opening operation (i.e., an opening operation of the door 100 that is closed). In the unlatched state of the door latch mechanism 60, the pawl permits the rotation of the latch that engages with the striker to thereby allow the door opening operation.

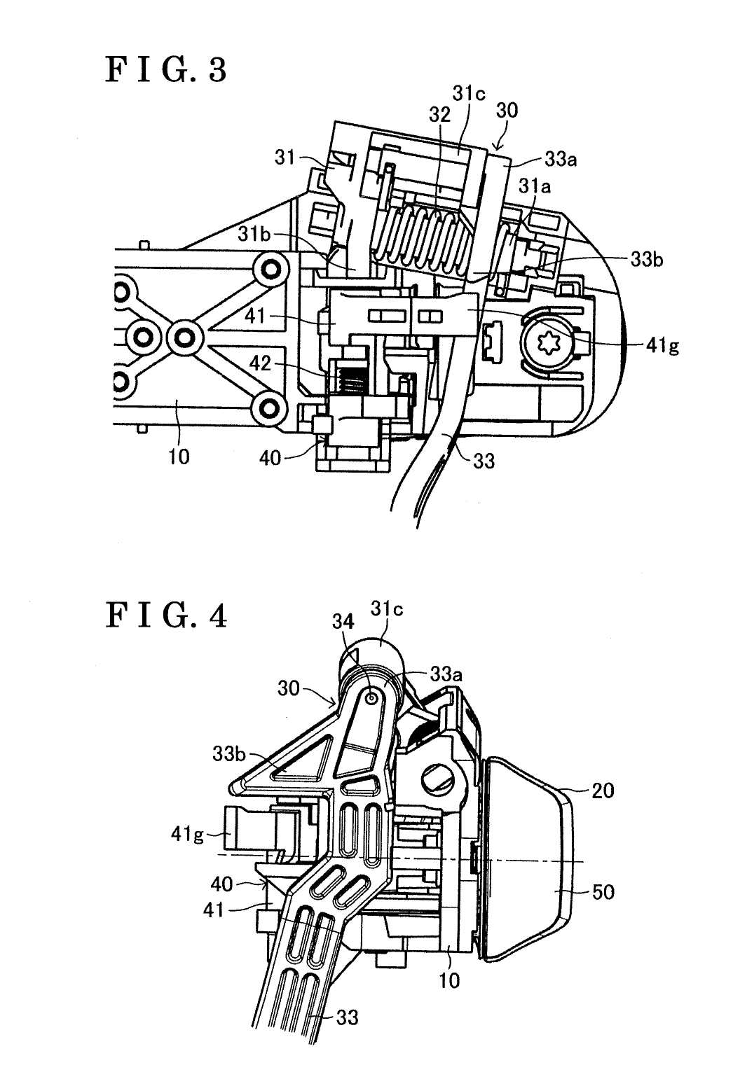

As illustrated in FIG. 3, the bell crank 31 includes a shaft portion 31a, an input arm portion 31b, and an output arm portion 31c. The bell crank 31 is rotatably mounted to the base member 10 at the shaft portion 31a. The input arm portion 31b extends at a radially lower side of the shaft portion 31a. An end of the input arm portion 31b is in contact or engagement with an outer side surface of the engagement portion 22a of the outer handle 20 as illustrated in FIG. 8. The output arm portion 31c extends at a radially upper side of the shaft portion 31a. The output arm portion 31c is connected to an upper end portion 33a of the connection lever 33 via a connection pin 34. At this time, the connection pin 34 may be integrally formed at the connection lever 33. In addition, a weight portion (an inertia portion) that extends along the shaft portion 31a may be provided at the output arm portion 31c. The weight portion at the output arm portion 31c is provided to restrict the door opening operation of the outer handle 20 that is caused by the inertia force applied to the door 100 in the vehicle outer direction in the event of a vehicle collision. Such restriction force of the weigh portion is specified depending on a mass of the weight portion and a biasing force of the coil spring 32.

The coil spring 32 is a return spring biasing the bell crank 31 and the outer handle 20 to a set position (i.e., in a set state and the door closed position) illustrated in FIGS. 2 to 8. The coil spring 32 is a component member of a return mechanism automatically returning the outer handle 20 from the door open position to the door closed position. The coil spring 32 is mounted on an outer periphery of the shaft portion 31a of the bell crank 31. The coil spring 32 engages with the base member 10 at one end and engages with the bell crank 31 at the other end. The coil spring 32 biases the bell crank 31 by a predetermined biasing force in a direction where the input arm portion 31b engages with the engagement portion 22a of the outer handle 20 (i.e., in a clockwise direction in FIG. 4). Thus, the input arm portion 31b of the bell crank 31 elastically engages with the engagement portion 22a of the outer handle 20.

The connection lever 33 includes the upper end portion 33a at which the connection lever 33 is connected to the output arm portion 31c of the bell crank 31 and includes a lower end portion at which the connection lever 33 is connected to an outside open lever that is connected to the pawl of the door latch mechanism 60. In a case where the bell crank 31 rotates by a predetermined amount against the biasing force of the coil spring 32 at a time when the outer handle 20 is operated from the door closed position to the door open position, the connection lever 33 moves downward by a predetermined amount from a set position (an initial position) as illustrated in FIGS. 3 and 4. The connection lever 33 integrally includes a projecting portion 33b having a triangular shape and being engageable with the lever member 41 of the door opening prevention mechanism 40.

In a case where the outer handle 20 is in the door closed position and the connection lever 33 is in the initial position while the door 100 is being closed, the door latch mechanism 60 is in the latched state. In addition, in a case where the outer handle 20 is operated from the door closed position to the door open position and thus the connection lever 33 moves downwardly by the predetermined amount from the initial position, the door latch mechanism 60 is brought to the unlatched state. Therefore, the rotation of the bell crank 31 against the biasing force of the coil spring 32 and the downward movement of the connection lever 33 each correspond to an operation in a door opening direction.

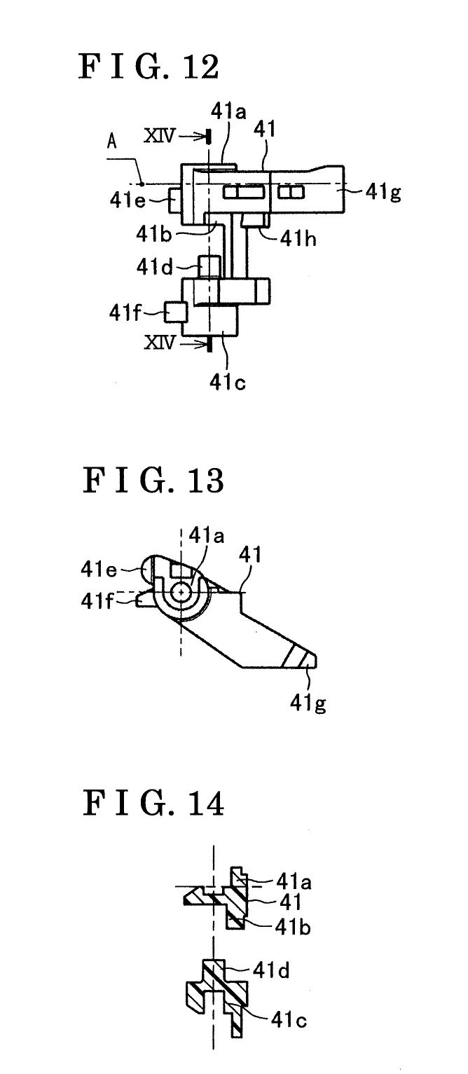

The door opening prevention mechanism 40 restricts the downward movement of the connection lever 33 of the link mechanism 30 (i.e., the operation in the door opening direction), which is caused by a predetermined inertia force applied to the door 100 in the vehicle outer direction in the event of the vehicle collision while the door 100 is being closed. The door opening prevention mechanism 40 includes the lever member 41 assembled on the base member 10 and a coil spring 42 assembled between the lever member 41 and the base member 10. Lines A illustrated in FIGS. 11 and 12 are reference lines matching each other in a vertical direction in a case where the lever member 41 is arranged in a set rotation position as illustrated in FIGS. 2 to 9.

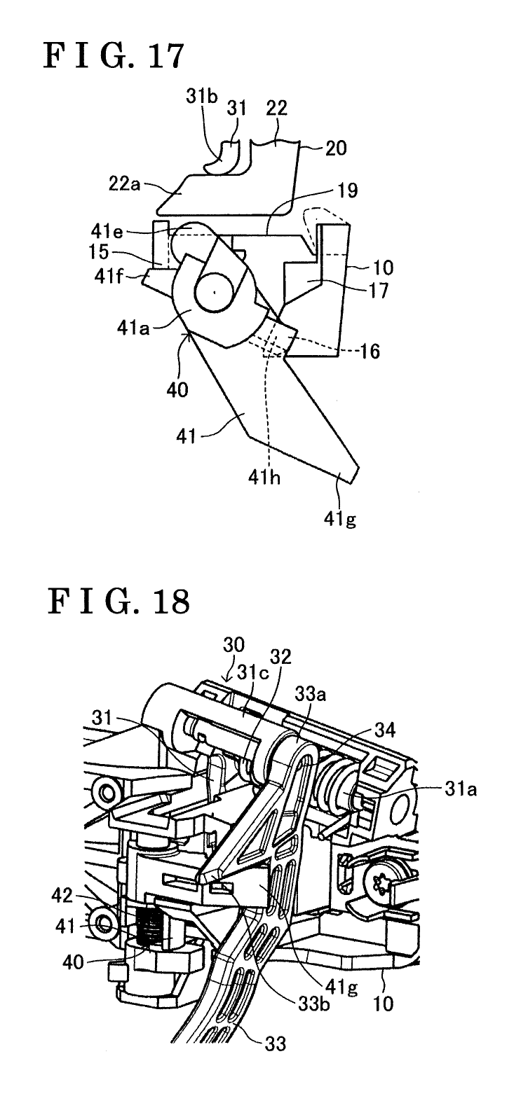

As illustrated in FIGS. 12 to 14, the lever member 41 includes an upper shaft portion 41a, an intermediate shaft portion 41b, a lower shaft portion 41c, and a spring attachment shaft portion 41d. The upper shaft portion 41a, the intermediate shaft portion 41b, and the lower shaft portion 41c each serve as a shaft portion. In addition, the lever member 41 includes an engagement projection 41e, a stopper projection 41f, a lever portion 41g, and a shoe portion 41h. The lever member 41 is rotatable from the set rotation position (i.e., an initial rotation position) illustrated in FIG. 8 to a retracted rotation position in the vehicle inner direction as illustrated in FIG. 17 or to a locked rotation position in the vehicle outer direction as illustrated in FIG. 22.

As illustrated in FIG. 7, the upper shaft portion 41a is assembled on an upper support portion 12 of the base member 10 so as to be rotatable and movable in an axial direction (i.e., in the vertical direction) by a predetermined amount. The intermediate shaft portion 41b is assembled on an intermediate support portion 13 of the base member 10 so as to be rotatable and movable in the axial direction by a predetermined amount. The lower shaft portion 41c is assembled on a lower support portion 14 of the base member 10 so as to be rotatable and movable in the axial direction by a predetermined amount.

The spring attachment shaft portion 41d is formed between the intermediate shaft portion 41b and the lower shaft portion 41c. A coil portion of the coil spring 42 is assembled on the spring attachment shaft portion 41d so as to be extendable. As illustrated in FIG. 8, the engagement projection 41e is engageable and disengageable relative to the engagement portion 22a of the outer handle 20. The engagement projection 41e is in engagement with the engagement portion 22a of the outer handle 20 until the stopper projection 41f makes contact with a stopper portion 15 of the base member 10 in association with the operation of the outer handle 20 from the door closed position to the door open position. After the stopper projection 41f makes contact with the stopper portion 15 of the base member 10, the engagement projection 41e disengages from the engagement portion 22a of the outer handle 20 as illustrated in FIG. 17. The stopper projection 41f is engageable and disengageable relative to the stopper portion 15 of the base member 10.

The lever portion 41g radially (i.e., substantially horizontally) extends from the upper shaft portion 41a and the intermediate shaft portion 41b by a predetermined amount. An end portion of the lever portion 41g extends or retracts relative to a lower side of the projecting portion 33b of the connection lever 33 that is in the initial position. As illustrated in FIGS. 8 and 9, the shoe portion 41h slidably engages with an upper stepped surface 16 or a lower stepped surface 17 formed at the base member 10. The shoe portion 41h includes an inclination surface 41h1. The shoe portion 41h (the inclination surface 41h1), an inclination surface (a wall surface) 18 formed between the upper stepped surface 16 and the lower stepped surface 17 of the base member 10, and the coil spring 42 constitute a holding mechanism HM1 for holding the lever member 41 at the locked rotation position.

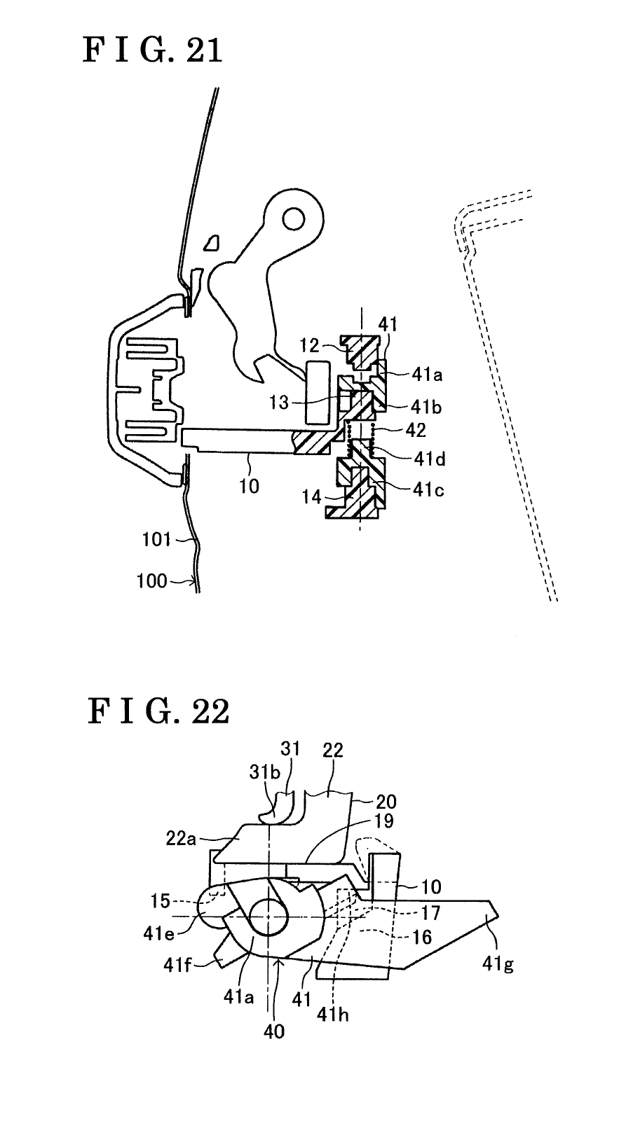

As illustrated in FIG. 7, the coil spring 42 is a biasing member mounted between the base member 10 and the lever member 41. Specifically, the coil spring 42 engages with the base member 10 at an upper end and engages with the lever member 41 at a lower end. The coil spring 42 biases the lever member 41 to rotate towards the retracted rotation position as illustrated in FIG. 17 and biases the lever member 41 in the axial direction towards a lower position (i.e., a lock holding position) as illustrated in FIG. 21.

In the holding mechanism HM1, the inclination surface 18 formed between the upper stepped surface 16 and the lower stepped surface 17 is formed substantially parallel to the inclination surface 41h1 formed at the shoe portion 41h as illustrated in FIG. 9. The inclination surface 18 forms an acute angle with the upper stepped surface 16 and the lower stepped surface 17. Thus, in a case where the lever member 41 once rotates to the locked rotation position, the lever member 41 is pressed downward by the coil spring 42 and the inclination surface 41h1 faces the inclination surface 18. Thus, thereafter the rotation of the lever member 41 from the locked rotation position to the set rotation position is restrained because of the contact and engagement between the inclination surface 41h1 and the inclination surface 18. The lever member 41 is held at the locked rotation position accordingly. The inclination surface 41h1 and the inclination surface 18 are each configured to form an acute angle with the upper stepped surface 16 and the lower stepped surface 17. Thus, the inclination surface 41h1 and the inclination surface 18 function as wedges when making contact and engaging with each other. At this time, for example, the inclination surface 41h1 and the inclination surface 18 may form a right angle with the upper stepped surface 16 and the lower stepped surface 17 (i.e., the inclination surface 41h1 and the inclination surface 18 may each form a vertical wall surface relative to the upper stepped surface 16 and the lower stepped surface 17 respectively).

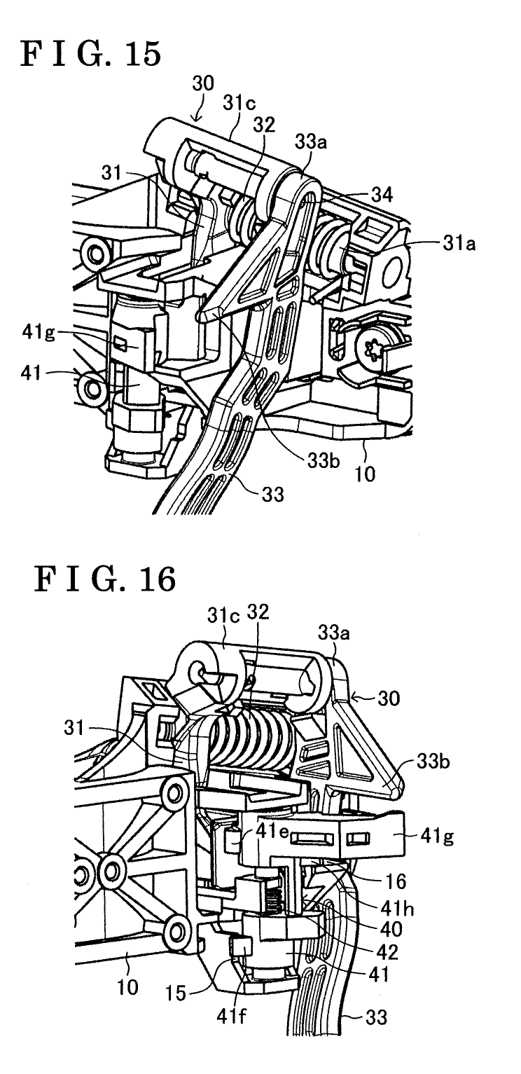

According to the door outer handle device having the aforementioned configuration, in a case where the outer door handle 20 is in the door closed position while the aforementioned inertia force (i.e., the predetermined inertia force applied to the door 100 in the vehicle outer direction) is not being applied, the lever member 41 is held at the set rotation position as illustrated in FIGS. 2 to 9. In a case where the outer handle 2 is operated from the door closed position to the door open position while the inertia force is not being applied, the engagement portion 22a of the outer handle 20 disengages from the engagement projection 41e of the lever member 41 in the early stage of the operation of the outer handle 20 from the door closed position to the door open position. Then, the lever member 41 rotates in the vehicle inner direction from the set rotation position by the biasing force of the coil spring 42. As a result, the lever member 41 moves to the retracted rotation position as illustrated in FIGS. 15 to 17. In a case where the inertia force is applied (in the event of the vehicle collision, for example), the lever member 41 rotates in the vehicle outer direction from the set rotation position against the biasing force of the coil spring 42 so as to move to the locked rotation position as illustrated in FIGS. 18 to 22 before the outer handle 20 is opened by the predetermined inertia force applied to the door 100 in the vehicle outer direction.

According to the present embodiment, in a case where the lever member 41 is arranged at the set rotation position or the locked rotation position, the lever portion 41g of the lever member 41 is positioned within a door opening direction movement locus of the connection lever 33 that is the component member of the link mechanism 30 to thereby restrict the connection lever 33 from moving in the door opening direction. In a case where the lever member 41 is arranged at the retracted rotation position, the lever portion 41g of the lever member 41 is positioned away from the door opening direction movement locus of the connection lever 33 to thereby allow the connection lever 33 to move in the door opening direction. When the lever member 41 is arranged at the set rotation position, the end portion of the lever portion 41g is positioned within the door opening direction movement locus of an end portion of the projecting portion 33b of the connection lever 33 as illustrated in FIGS. 2 to 6. When the lever member 41 is arranged at the locked rotation position, an intermediate portion of the lever portion 41g is positioned within the door opening direction movement locus of a base portion of the projecting portion 33b of the connection lever 33 as illustrated in FIGS. 18 to 20. Thus, when the lever member 41 is at the locked rotation position, an engageable area between the lever portion 41g of the lever member 41 and the projecting portion 33b of the connection lever 33 increases as compared to a case where the lever member 41 is at the set rotation position.

Thus, according to the present embodiment, even when an operation responsiveness of the lever member 41 in the vehicle outer direction by the inertia force is insufficient in the event of the vehicle collision (i.e., when a timing that the lever member 41 moves from the set rotation position to the locked rotation position by the predetermined inertia force is delayed), the connection lever 33 is restricted from moving in the opening direction by the lever member 41 in the set rotation position. The unlatched operation (i.e., the operation to shift the door 100 from the closed state (the latched state) to the open state (the unlatched state)) of the door latch mechanism 60 is securely restrained accordingly.

In addition, according to the present embodiment, in a case where the outer handle 20 is operated from the door closed position to the door open position while the inertia force is not being applied, the lever member 41 rotates in the vehicle inner direction from the set rotation position so as to move to the retracted rotation position in the early stage of the operation from the door closed position to the door open position of the outer handle 20. In a case where the outer handle 20 is returned from the door open position to the door closed position while the inertia force is not being applied, the lever member 41 rotates in the vehicle outer direction from the retracted rotation position so as to move to the set rotation position in the late stage of the operation from the door open position to the door closed position of the outer handle 20. Accordingly, the lever member 41 rotates between the set rotation position and the retracted rotation position together with the coil spring 42 in association with a normal operation of the outer handle 20 (i.e., a normal door opening operation). As a result, an attachment and a resulting solidification of dirt or dust at a rotating portion of the lever member 41 may be restrained, which leads to a long term guarantee of the rotation of the lever member 41. The rotation of the lever member 41 at a time of a possible vehicle collision may be maintained and guaranteed.

Further, according to the present embodiment, the door opening prevention mechanism 40 includes the holding mechanism HM1 holding the lever member 41 at the locked rotation position as illustrated in FIG. 9. Thus, in a case where the inertia force is applied to the lever member 41 so that the lever member 41 moves from the set rotation position to the locked rotation position, the lever member 41 moves axially downward (i.e., in a leftward direction in FIG. 9) by the biasing force of the coil spring 42 in the axial direction so that the inclination surface 41h1 of the shoe portion 41h makes contact and engages with the inclination surface 18 of the base member 10. Accordingly, the lever member 41 is held at the locked rotation position by the holding mechanism HM1.

Accordingly, in a case where the lever member 41 moves from the set rotation position to the locked rotation position by the predetermined inertia force applied to the lever member 41, the holding mechanism HM1 holds the lever member 41 at the locked rotation position. Thus, even thereafter the inertia force applied to the lever member 41 fluctuates and decreases so that the resulting inertia force becomes smaller than the biasing force of the coil spring 42, for example, the lever member 41 is held at the locked rotation position by the holding mechanism HM1. The lever member 41 is restrained from returning to the set rotation position from the locked rotation position by the biasing force of the coil spring 42. Regardless of the fluctuation of the inertia force, the function of the door opening prevention mechanism 40 is maintained, which leads to an improved safety of the door outer handle device of the embodiment.

Furthermore, according to the aforementioned embodiment, the lever member 41 includes the engagement projection 41e serving as a first engagement portion and the stopper projection 41f serving as a second engagement portion. In a case where the lever member 41 is in the set rotation position, the engagement projection 41e engages with the engagement portion 22a of the outer handle 20 in the door closed position to thereby restrict the rotation of the lever member 41 by the coil spring 42. In a case where the lever member 41 is in the retracted rotation position, the stopper projection 41f engages with the stopper portion 15 of the base member 10 to thereby restrict the rotation of the lever member 41 by the coil spring 42.

Accordingly, the outer handle 20 and the lever member 41 are contactable or connectable by a simple structure, i.e., by the engagement portion 22a of the outer handle 20 and the engagement projection 41e of the lever member 41. In addition, the rotation of the lever member 41 relative to the base member 10 is restricted by a simple structure, i.e., by the stopper portion 15 of the base member 10 and the stopper projection 41f of the lever member 41. As a result, the door outer handle device at a low cost is achievable. Further, the rotation of the lever member 41 relative to the base member 10 is regulated to a minimum level, which leads to a space reduction in the door outer handle device.

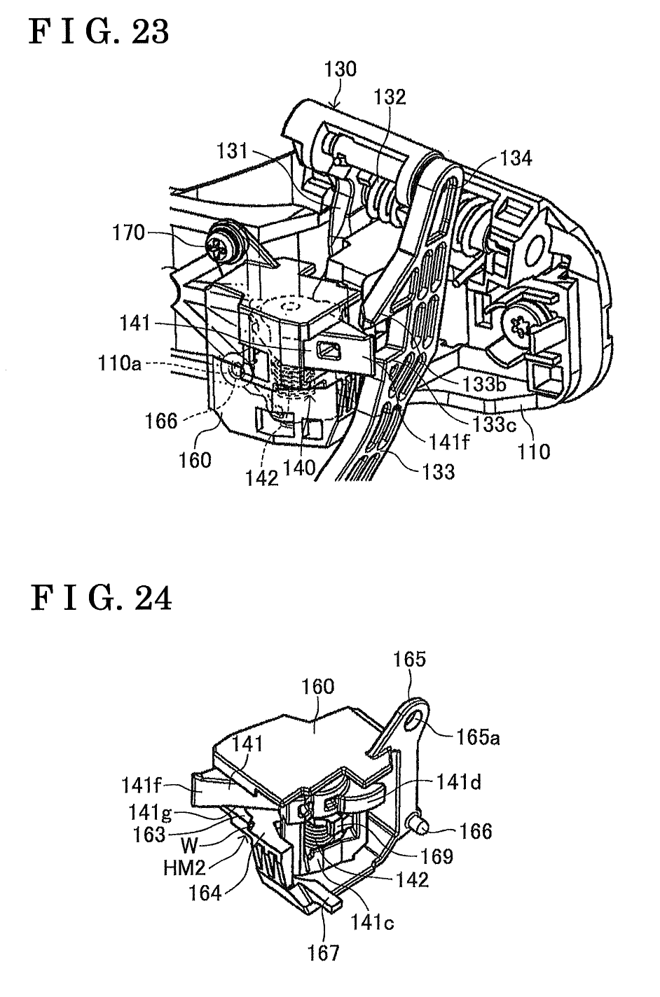

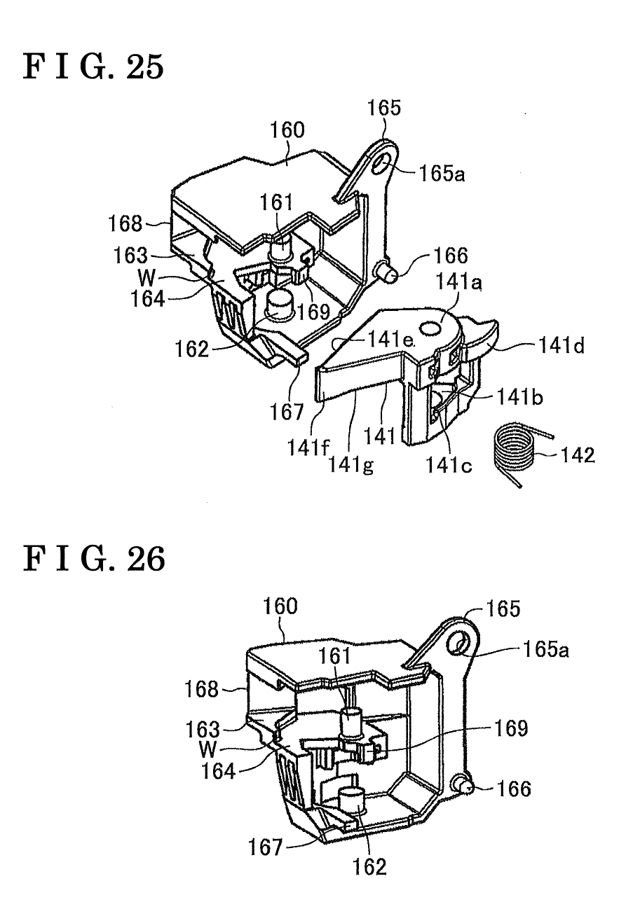

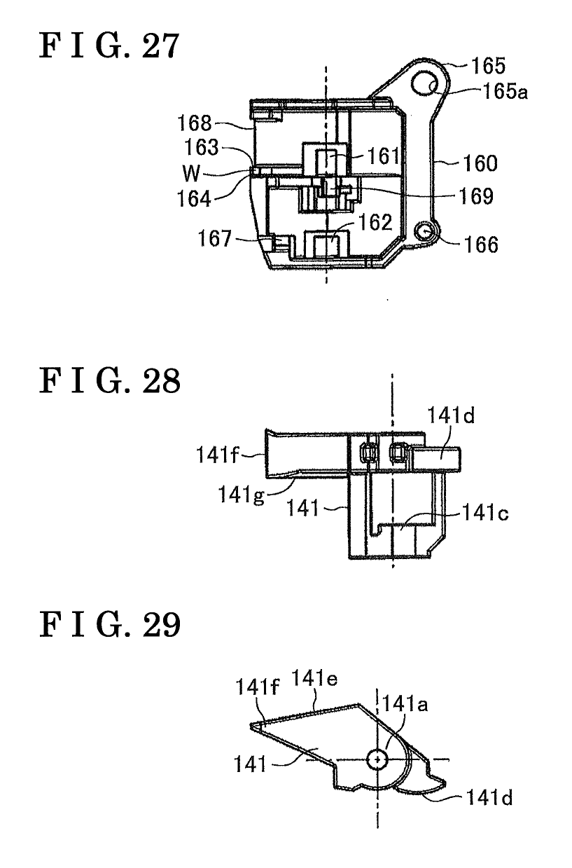

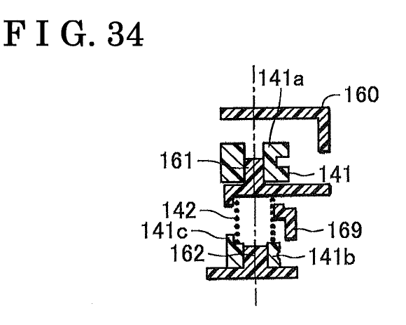

According to the aforementioned first embodiment as illustrated in FIGS. 1 to 22, the lever member 41 of the door opening prevention mechanism 40 is directly assembled on the base member 10 so that the lever member 41 is rotatable relative to the base member 10 by a predetermined amount. According to a second embodiment as illustrated in FIGS. 23 to 34, a lever member 141 of a door opening prevention mechanism 140 is assembled on a base member 110 via a case 160 so that the lever member 141 is rotatable relative to the base member 110 by a predetermined amount.

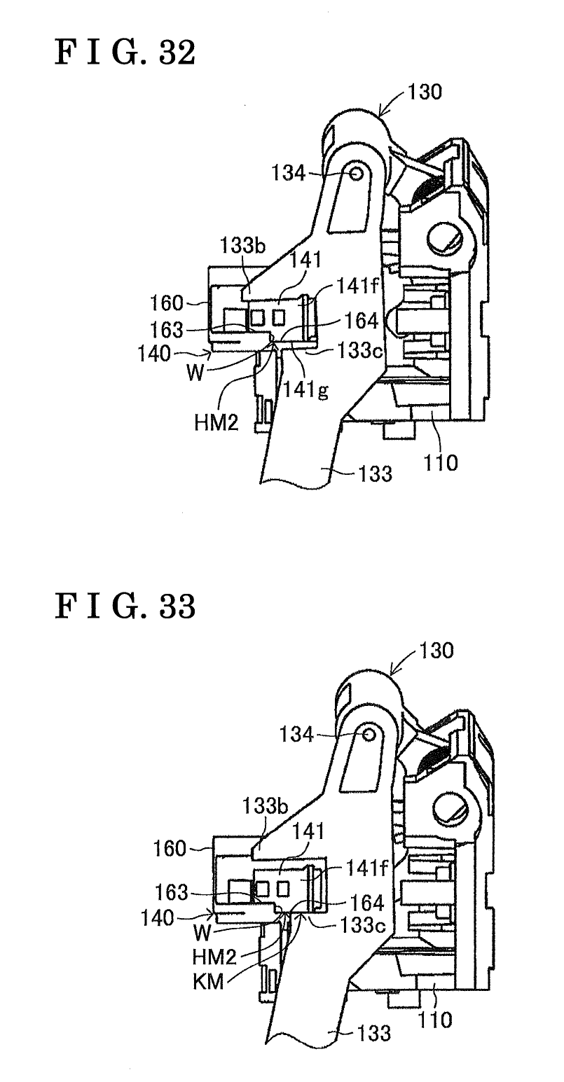

A door outer handle device for a vehicle according to the second embodiment includes a holding mechanism HM2 (see FIGS. 24 and 32) similar to the holding mechanism HM1 of the first embodiment. The second embodiment also includes a lock release mechanism KM (see FIG. 33). Further, the second embodiment includes a link mechanism 130 similar to the link mechanism 30 of the first embodiment. Configurations of the link mechanism 130 such as a bell crank 131, a coil spring 132, a connection lever 133 and a connection pin 134, except for a shape of the connection lever 133, are substantially the same as those of the link mechanism 30 of the first embodiment such as the bell crank 31, the coil spring 32, the connection lever 33, and the connection pin 34. Thus, explanations of the similar configurations of the second embodiment to the first embodiment will be omitted.

As illustrated in FIGS. 23 to 27, the case 160 covers and protects a large portion of the lever member 141 (i.e., fails to cover or protect only a portion thereof) and substantially an entire portion of a coil spring 142. The case 160 includes an upper support portion 161 (shaft portion) and a lower support portion 162 (shaft portion) corresponding to the upper support portion 12, the intermediate support portion 13, and the lower support portion 14 of the first embodiment, and an upper stepped surface 163 and a lower stepped surface 164 corresponding to the upper stepped surface 16 and the lower stepped surface 17 of the first embodiment.

Further, the case 160 includes an attachment piece 165 having an attachment bore 165a, a positioning pin 166 fitted to a pin bore 110a formed at the base member 110 in a case where the case 160 is assembled on the base member 110, and a detent projection 167 inhibiting the case 160 from rotating when the case 160 is assembled on the base member 110 by a screw 170. The detent projection 167 is configured to engage with a portion of the base member 110.

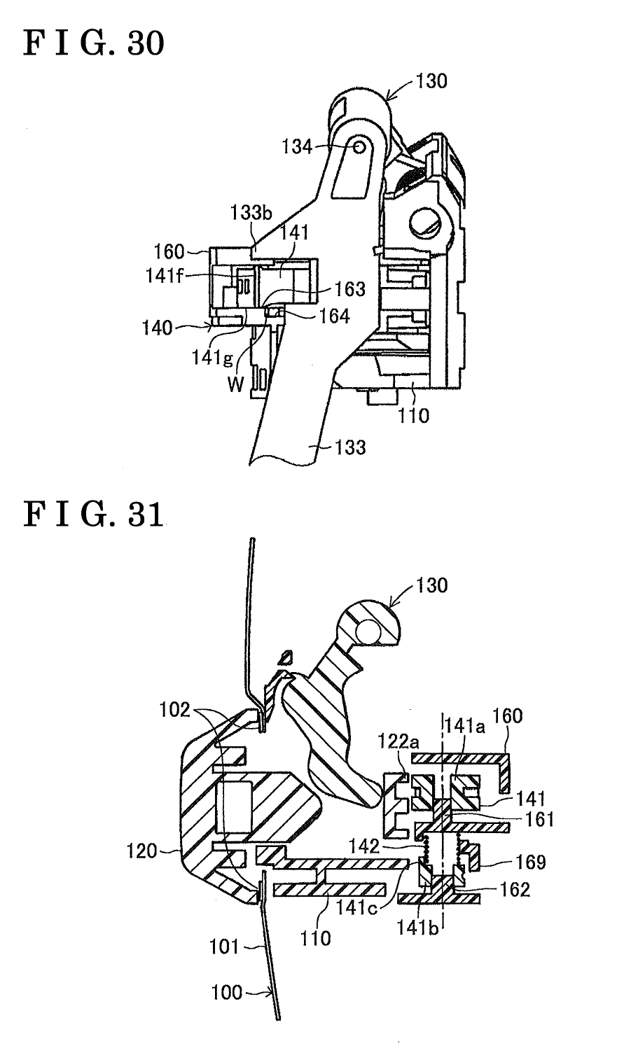

As illustrated in FIGS. 23 to 25, 28, and 29, the lever member 141 includes an upper shaft portion (hollow shaft portion) 141a, a lower shaft portion (hollow shaft portion) 141b, and a spring holding portion 141c. The lever member 141 also includes an engagement projection 141d, a stopper engagement portion 141e, a lever portion 141f, and a shoe portion 141g. The lever member 141 is rotatable from the set rotation position (i.e., the initial rotation position) illustrated in FIGS. 23 and 30 to the retracted rotation position in the vehicle inner direction or to the locked rotation position in the vehicle outer direction as illustrated in FIGS. 32 to 34.

The upper shaft portion 141a is assembled on the upper support portion 161 of the case 160 so as to be rotatable and axially movable (i.e., movable in the vertical direction) by a predetermined amount relative to the upper support portion 161. The lower shaft portion 141b is assembled on the lower support portion 162 of the case 160 so as to be rotatable and axially movable (i.e., movable in the vertical direction) by a predetermined amount relative to the lower support portion 162. The spring holding portion 141c is provided between the upper shaft portion 141a and the lower shaft portion 141b so that a lower end portion of the coil spring 142 expands and contracts.

The engagement projection 141d is engageable and disengageable relative to an engagement portion 122a of an outer handle 120. The engagement projection 141d is in engagement with the engagement portion 122a of the outer handle 120 until the stopper engagement portion 141e makes contact with a stopper portion 168 of the case 160 in association with the operation of the outer handle 120 from the door closed position to the door open position. After the stopper engagement portion 141e makes contact with the stopper portion 168 of the case 160, the engagement projection 141d disengages from the engagement portion 122a of the outer handle 120. The stopper engagement portion 141e is engageable and disengageable relative to the stopper portion 168 of the case 160.

The lever portion 141f radially (i.e., substantially horizontally) extends from the upper shaft portion 141a by a predetermined amount. An end portion of the lever portion 141f extends or retracts relative to a lower side of a projecting portion 133b of the connection lever 133 that is in the initial position. As illustrated in FIGS. 30 and 32, the shoe portion 141g slidably engages with the upper stepped surface 163 or the lower stepped surface 164 formed at the case 160. The shoe portion 141g includes a vertical wall. The shoe portion 141g (the vertical wall), a vertical wall surface W formed between the upper stepped surface 163 and the lower stepped surface 164 of the case 160, and the coil spring 142 constitute a holding mechanism HM2 for holding the lever member 141 at the locked rotation position.

As illustrated in FIGS. 24 and 31, the coil spring 142 is a biasing member mounted between the case 160 and the lever member 141. Specifically, the coil spring 142 engages with the case 160 at an upper end and engages with the lever member 141 at a lower end. The coil spring 142 biases the lever member 141 to rotate towards the retracted rotation position and biases the lever member 141 in the axial direction towards a lower position (i.e., the lock holding position) as illustrated in FIGS. 32 to 34. A coil portion of the coil spring 142 is held by the spring holding portion 141c formed at the lever member 141 and also by a spring holding portion 169 formed at the case 160.

The lock release mechanism KM releases the lever member 141, which is held at the locked rotation position by the holding mechanism HM2 in association with a return operation by the coil spring 132 (return mechanism) of the link mechanism 130, from the locked rotation position. Specifically, the lock release mechanism KM upwardly presses the lever member 141 against the biasing force of the coil spring 142 in the axial direction. The lock release mechanism KM is constituted by a release portion 133c formed at the lever member 141. The lever member 141 that is released from the locked rotation position by the lock release mechanism KM is configured to return to the set rotation position by the biasing force of the coil spring 142 (biasing member).

The second embodiment is configured in the substantially same manner as the first embodiment except that the door opening prevention mechanism 140 includes the lock release mechanism KM, and the lever member 141 of the door opening prevention mechanism 140 is assembled on the base member 110 via the case 160. Accordingly, the second embodiment obtains substantially the same effects as those of the first embodiment.

Further, according to the second embodiment, the case 160 is provided so as to cover and protect the large portion of the lever member 141 and substantially the entire portion of the coil spring 142. Thus, the lever member 141, the coil spring 142, and the like are unlikely to be adversely affected by dust, dirt, water, and the like. For example, a rotation failure of the lever member 141 is restrained, thereby improving reliability of the door outer handle device.

Furthermore, according to the second embodiment, the lock release mechanism KM (the release portion 133c) is provided so as to release the lever member 141, which is held at the locked rotation position by the holding mechanism HM2 in association with the return operation by the coil spring 132 of the link mechanism 130, from the locked rotation position. The lever member 141 that is released from the locked rotation position by the lock release mechanism KM is configured to return to the set rotation position by the biasing force of the coil spring 142. Therefore, after the vehicle collision (i.e., the inertia force disappears), the lever member 141 is released from the locked rotation position so as to return to the set rotation position by a cooperation of the coil spring 132, the lock release mechanism KM, the coil spring 142, and the like. Therefore, after the vehicle collision, the outer handle 120 is operated from the door closed position to the door open position to thereby open the door 100.

According to the aforementioned first and second embodiments, the lever member 41, 141 of the door opening prevention mechanism 40, 140 is extendable and retractable relative to the connection lever 33, 133 of the link mechanism 30, 130, i.e., the lever member 41, 141 is positioned within the door opening direction movement locus of the projecting portion 33b, 133b of the connection lever 33, 133 or is positioned out of the door opening direction movement locus of the projecting portion 33b, 133b. Alternatively, the lever member 41, 141 of the door opening prevention mechanism 40, 140 may be extendable and retractable relative to the other component member, such as a rod and a bell crank, than the connection lever 33, 133 of the link mechanism 30, 130. In addition, the projecting portion 33b, 133b of the connection lever 33, 133 may be provided as a separate member.

In addition, according to the aforementioned first and second embodiments, the holding mechanism HM1, HM2 is provided to hold the lever member 41, 141 at the locked rotation position. The holding mechanism HM1, HM2 may be omitted to achieve the door outer handle device of the embodiments. Further, according to the first embodiment, the stopper projection 41f is formed at the lever member 41 while the stopper portion 15 is formed at the base member 10. The stopper projection 41f and the stopper portion 15 may not be provided to achieve the door outer handle device of the first embodiment. Furthermore, a weight portion (an inertia portion) may be provided at the bell crank 31, 131.

Furthermore, according to the aforementioned first and second embodiments, the lever member 41, 141 of the door opening prevention mechanism 40, 140 is rotatable from the set rotation position in the vehicle inner direction to the retracted rotation position or in the vehicle outer direction to the locked rotation position. In the event of the vehicle collision, the lever member 41, 141 rotates from the set rotation position in the vehicle outer direction to the locked rotation position against the biasing force of the coil spring 42, 142 (the biasing member) by the predetermined inertia force (i.e., the inertia force is applied to the lever member 41, 141). Alternatively, the lever member 41, 141 of the door opening prevention mechanism 40, 140 may be rotatable from the set rotation position in the vehicle inner direction to the retracted rotation position. Then, in the event of the vehicle collision, the lever member 41, 141 may be retained at the set rotation position against the biasing force of the coil spring 42, 142 by the predetermined inertia force (i.e., the locked rotation position in the vehicle outer direction may not be specified and thus the lever member 41, 141 is configured not to move to the locked rotation position by the predetermined inertial force in the event of the vehicle collision). In addition, according to the aforementioned embodiment, the lever member 41, 141 of the door opening prevention mechanism 40, 140 and the component member of the link mechanism 30, 130 such as the connection lever 33, 133 are separately formed. Alternatively, the lever member 41, 141 and the component member of the link mechanism 30, 130 may be integrally formed. Then, the resulting integral member may move to the set rotation position, the retracted rotation position, and the locked rotation position.

Furthermore, according to the aforementioned first and second embodiments, the door outer handle device is provided to the door 100 at a right rear side of the vehicle. Alternatively, the door outer handle device of the embodiment may be provided to the door 100 at a left rear side, a right front side, or a left front side of the vehicle in the same way or in an appropriately modified manner. The door outer handle device may be applicable to a door at a rear side of the vehicle (i.e., a back door) in the same way or in an appropriately modified manner.

The door outer handle device of the present embodiment includes the base member 10, 110 configured to be fixed to the door 100 for the vehicle, the outer handle 20, 120 attached to the base member 10, 110 in a movable manner in the vehicle inner and outer directions, the outer handle 20, 120 being operable between the door closed position and the door open position, the door open position being arranged in the vehicle outer direction relative to the door closed position, the link mechanism 30, 130 configured to transmit the door opening operation of the outer handle 20, 120 as the unlatched operation of the door latch mechanism 60, and the door opening prevention mechanism 40, 140 restricting the connection lever 33, 133 of the link mechanism 30, 130 from moving in the door opening direction by the predetermined inertia force applied to the door 100 in the vehicle outer direction. The door opening prevention mechanism 40, 140 includes the lever member 41, 141 being rotatable to the set rotation position where the lever member 41, 141 is held at the base member 10, 110 to restrict the connection lever 33, 133 of the link mechanism 30, 130 from moving in the door opening direction in a case where the outer handle 20, 120 is arranged at the door closed position. The lever member 41, 141 is rotatable to the retracted rotation position that is positioned at least in the vehicle inner direction from the set rotation position. The lever member 41, 141 is shifted to the retracted rotation position in the early stage of the operation of the outer handle 20, 120 from the door closed position to the door open position in a case where the outer handle 20, 120 is operated from the door closed position to the door open position in a state where the inertia force is prevented from being applied. The lever member 41, 141 allows the connection lever 33, 133 of the link mechanism 30, 130 to move in the door opening direction when the lever member 41, 141 is arranged at the retracted rotation position. The door opening prevention mechanism 40, 140 further includes the coil spring 42, 142 biasing the lever member 41, 141 to the retracted rotation position.

Accordingly, in a case where the lever member 41, 141 is arranged at the set rotation position, the lever member 41, 141 restricts the connection lever 33, 133 from moving in the door opening direction. Thus, in the event of the vehicle collision, the lever member 41, 141 at the set rotation position restricts the connection lever 33, 133 from moving in the door opening direction to thereby securely prevent the unlatched operation of the door latch mechanism 60 (i.e., an operation to shift the door 100 from the door closed state (latched state) to the door open state (the unlatched state)).

In addition, in a case where the outer handle 20, 120 is operated from the door closed position to the door open position in a state where the inertia force is not applied, the lever member 41, 141 rotates from the set rotation position in the vehicle inner direction to the retracted rotation position in the early stage of the operation from the door closed position to the door open position of the outer handle 20, 120 (on the other hand, in a case where the outer handle 20, 120 is returned from the door open position to the door closed position in a state where the inertia force is not applied, the lever member 41, 141 rotates from the retracted rotation position in the vehicle outer direction to move to the set rotation position in the later stage of the operation from the door open position to the door closed position of the outer handle 20, 120.) Thus, the lever member 41, 141 operates together with the coil spring 42, 142 in association with the normal operation (i.e., the normal door opening operation) of the outer handle 20, 120 so as to rotate between the set rotation position and the retracted rotation position. Consequently, an attachment and solidification of dirt or dust at a rotation portion of the lever member 41, 141 may be restrained, which leads to a long term guarantee of the rotation of the lever member 41, 141.

The lever member 41, 141 is maintained at the set rotation position against the biasing force of the coil spring 42, 142 in a state where the inertia force is applied.

Accordingly, in the event of the vehicle collision, the lever member 41, 141 at the set rotation position restricts the connection lever 33, 133 from moving in the door opening direction to thereby securely prevent the unlatched operation of the door latch mechanism 60.

The door outer handle device of the present embodiment includes the base member 10, 110 configured to be fixed to the door 100 for the vehicle, the outer handle 20, 120 attached to the base member 10, 110 in a movable manner in the vehicle inner and outer directions, the outer handle 20, 120 being operable between the door closed position and the door open position, the door open position being arranged in the vehicle outer direction relative to the door closed position, the link mechanism 30, 130 configured to transmit the door opening operation of the outer handle 20, 120 as the unlatched operation of the door latch mechanism 60, and the door opening prevention mechanism 40, 140 restricting the connection lever 33, 133 of the link mechanism 30, 130 from moving in the door opening direction by the predetermined inertia force applied to the door 100 in the vehicle outer direction. The door opening prevention mechanism 40, 140 includes the lever member 41, 141 being rotatable to the set rotation position where the lever member 41, 141 is held at the base member 10, 110 to restrict the connection lever 33, 133 of the link mechanism 30, 130 from moving in the door opening direction in a case where the outer handle 20, 120 is arranged at the door closed position in a state where the inertia force is prevented from being applied. The lever member 41, 141 is rotatable to the retracted rotation position that is positioned at least in the vehicle inner direction from the set rotation position. The lever member 41, 141 is shifted to the retracted rotation position in the early stage of the operation of the outer handle 20, 120 from the door closed position to the door open position in a case where the outer handle 20, 120 is operated from the door closed position to the door open position in a state where the inertia force is prevented from being applied. The lever member 41, 141 allows the connection lever 33, 133 of the link mechanism 30, 130 to move in the door opening direction when the lever member 41, 141 is arranged at the retracted rotation position. The lever member 41, 141 is rotatable to the locked rotation position that is positioned at least in the vehicle outer direction from the set rotation position. The lever member 41, 141 is shifted to the locked rotation position to restrict the connection lever 33, 133 of the link mechanism 30, 130 from moving in the door opening direction in a state where the inertia force is applied. The door opening prevention mechanism 40, 140 further includes the coil spring 42, 142 biasing the lever member 41, 141 to the retracted rotation position.

Accordingly, in a case where the lever member 41, 141 is arranged at the set rotation position or the locked rotation position, the lever member 41, 141 restricts the connection lever 33, 133 from moving in the door opening direction. Thus, in the event of the vehicle collision, the lever member 41, 141 in the set rotation position or the locked rotation position restricts the connection lever 33, 133 from moving in the door opening direction to thereby securely prevent the unlatched operation of the door latch mechanism 60.

In addition, in a case where the outer handle 20, 120 is operated from the door closed position to the door open position in a state where the inertia force is not applied, the lever member 41, 141 rotates from the set rotation position in the vehicle inner direction to the retracted rotation position in the early stage of the operation from the door closed position to the door open position of the outer handle 20, 120 (on the other hand, in a case where the outer handle 20, 120 is returned from the door open position to the door closed position in a state where the inertia force is not applied, the lever member 41, 141 rotates from the retracted rotation position in the vehicle outer direction to move to the set rotation position in the later stage of the operation from the door open position to the door closed position of the outer handle 20, 120.) Thus, the lever member 41, 141 operates together with the coil spring 42, 142 in association with the normal operation (i.e., the normal door opening operation) of the outer handle 20, 120 so as to rotate between the set rotation position and the retracted rotation position. Consequently, an attachment and solidification of dirt or dust at a rotation portion of the lever member 41, 141 may be restrained, which leads to a long term guarantee of the rotation of the lever member 41, 141.

The lever member 41, 141 is shifted to the locked rotation position against the biasing force of the coil spring 42, 142 in a state where the inertia force is applied.

Accordingly, in the event of the vehicle collision, the lever member 41, 141 at the locked rotation position restricts the connection lever 33, 133 from moving in the door opening direction to thereby securely prevent the unlatched operation of the door latch mechanism 60.

The lever member 41 includes the engagement projection 41e and the stopper projection 41f, the engagement projection 41e engaging with a portion of the outer handle 20 in the door closed position and restricting the lever member 41 from rotating by the coil spring 42 in a case where the lever member 41 is arranged at the set rotation position, the stopper projection 41f engaging with the base member 10 and restricting the lever member 41 from rotating by the coil spring 42 in a case where the lever member 41 is arranged at the retracted rotation position.

Accordingly, the outer handle 20 and the lever member 41 are contactable or connectable by a simple structure, i.e., by the portion of the outer handle 20 and the engagement projection 41e of the lever member 41. In addition, the rotation of the lever member 41 relative to the base member 10 is restricted by a simple structure, i.e., by the base member 10 and the stopper projection 41f of the lever member 41. As a result, a low cost is achievable according to the door outer handle device of the embodiment. Further, the rotation of the lever member 41 relative to the base member 10 is regulated to a minimum level, which leads to a space reduction in the door outer handle device.

The outer handle 20 includes the engagement portion 22a engaging with the link mechanism 30 and selectively engaging with the engagement projection 41e.

Accordingly, the outer handle 20 and the lever member 41 are contactable or connectable by a simple structure, i.e., by the engagement portion 22a of the outer handle 20 and the engagement projection 41e of the lever member 41. As a result, a low cost is achievable according to the door outer handle device of the embodiment.

The base member 10 includes the stopper portion 15 selectively engaging with the stopper projection 41f.

Accordingly, the rotation of the lever member 41 relative to the base member 10 is restricted by a simple structure, i.e., by the stopper portion 15 of the base member 10 and the stopper projection 41f of the lever member 41. As a result, a low cost is achievable according to the door outer handle device of the embodiment. Further, the rotation of the lever member 41 relative to the base member 10 is regulated to a minimum level, which leads to a space reduction in the door outer handle device.

The door opening prevention mechanism 40 includes the holding mechanism HM1, HM2 to hold the lever member 41, 141 at the locked rotation position.

Accordingly, in a case where the lever member 41, 141 moves from the set rotation position to the locked rotation position by the predetermined inertia force applied to the lever member 41, 141 in the event of the vehicle collision, the holding mechanism HM1, HM2 holds the lever member 41, 141 at the locked rotation position. Thus, even thereafter the inertia force applied to the lever member 41, 141 fluctuates and decreases so that the resulting inertia force becomes smaller than the biasing force of the coil spring 42, 142, for example, the lever member 41, 141 is held at the locked rotation position by the holding mechanism HM1, HM2 and is restrained from returning to the set rotation position from the locked rotation position by the biasing force of the coil spring 42, 142. Regardless of the fluctuation of the inertia force, the function of the door opening prevention mechanism 4, 140 is maintained, which leads to an improved safety of the door outer handle device.

The holding mechanism HM1 includes the shoe portion 41h engaging with the base member 10 in a direction from the locked rotation position to the set rotation position of the lever member 41. The lever member 41 includes the upper shaft portion 41a, the intermediate shaft portion 41b, and the lower shaft portion 41c assembled on the base member 10 to be rotatable and movable in the axial direction of the lever member 41. The coil spring 42 biases the lever member 41 in the axial direction so that the shoe portion 41h engages with the base member 10.

Accordingly, in a case where the lever member 41 moves from the set rotation position to the locked rotation position by the predetermined inertia force applied to the lever member 41 in the event of the vehicle collision, the holding mechanism HM1 holds the lever member 41 at the locked rotation position. Thus, even thereafter the inertia force applied to the lever member 41 fluctuates and decreases so that the resulting inertia force becomes smaller than the biasing force of the coil spring 42, for example, the lever member 41 is held at the locked rotation position by the holding mechanism HM1 and is restrained from returning to the set rotation position from the locked rotation position by the biasing force of the coil spring 42, 142. Regardless of the fluctuation of the inertia force, the function of the door opening prevention mechanism 40 is maintained, which leads to an improved safety of the door outer handle device.

The link mechanism 130 includes the coil spring 132 automatically returning the outer handle 120 from the door open position to the door closed position and the lock release mechanism KM releasing the lever member 141, which is held at the locked rotation position by the holding mechanism HM2 in association with the return operation by the coil spring 132, from the locked rotation position.

Accordingly, the lever member 141 that is released from the locked rotation position by the lock release mechanism KM is configured to return to the set rotation position by the biasing force of the coil spring 142. Therefore, after the vehicle collision (i.e., the inertia force disappears), the lever member 141 is released from the locked rotation position so as to return to the set rotation position by a cooperation of the coil spring 132, the lock release mechanism KM, the coil spring 142, and the like. Therefore, after the vehicle collision, the outer handle 120 is operated from the door closed position to the door open position to thereby open the door 100.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A door outer handle device for a vehicle, comprising:
a base member configured to be fixed to a door for the vehicle;
an outer handle attached to the base member in a movable manner in vehicle inner and outer directions, the outer handle being operable between a door closed position and a door open position, the door open position being arranged in the vehicle outer direction relative to the door closed position;
a link mechanism configured to transmit a door opening operation of the outer handle as an unlatched operation of a door latch mechanism; and
a door opening prevention mechanism restricting a component member of the link mechanism from moving in a door opening direction by a predetermined inertia force applied to the door in the vehicle outer direction;
the door opening prevention mechanism including a lever member being rotatable to a set rotation position where the lever member is held at the base member to restrict the component member of the link mechanism from moving in the door opening direction in a case where the outer handle is arranged at the door closed position, the lever member being rotatable to a retracted rotation position that is positioned at least in the vehicle inner direction from the set rotation position, the lever member being shifted to the retracted rotation position in an early stage of an operation of the outer handle from the door closed position to the door open position in a case where the outer handle is operated from the door closed position to the door open position in a state where the inertia force is prevented from being applied, the lever member allowing the component member of the link mechanism to move in the door opening direction when the lever member is arranged at the retracted rotation position, the door opening prevention mechanism further including a biasing member biasing the lever member to the retracted rotation position.

2. The door outer handle device according to claim 1, wherein the lever member is maintained at the set rotation position against a biasing force of the biasing member in a state where the inertia force is applied.

3. A door outer handle device for a vehicle, comprising:
a base member configured to be fixed to a door for the vehicle;
an outer handle attached to the base member in a movable manner in vehicle inner and outer directions, the outer handle being operable between a door closed position and a door open position, the door open position being arranged in the vehicle outer direction relative to the door closed position;
a link mechanism configured to transmit a door opening operation of the outer handle as an unlatched operation of a door latch mechanism; and
a door opening prevention mechanism restricting a component member of the link mechanism from moving in a door opening direction by a predetermined inertia force applied to the door in the vehicle outer direction;
the door opening prevention mechanism including a lever member being rotatable to a set rotation position where the lever member is held at the base member to restrict the component member of the link mechanism from moving in the door opening direction in a case where the outer handle is arranged at the door closed position in a state where the inertia force is prevented from being applied, the lever member being rotatable to a retracted rotation position that is positioned at least in the vehicle inner direction from the set rotation position, the lever member being shifted to the retracted rotation position in an early stage of an operation of the outer handle from the door closed position to the door open position in a case where the outer handle is operated from the door closed position to the door open position in a state where the inertia force is prevented from being applied, the lever member allowing the component member of the link mechanism to move in the door opening direction when the lever member is arranged at the retracted rotation position, the lever member being rotatable to a locked rotation position that is positioned at least in the vehicle outer direction from the set rotation position, the lever member being shifted to the locked rotation position to restrict the component member of the link mechanism from moving in the door opening direction in a state where the inertia force is applied, the door opening prevention mechanism further including a biasing member biasing the lever member to the retracted rotation position.

4. The door outer handle device according to claim 3, wherein the lever member is shifted to the locked rotation position against a biasing force of the biasing member in a state where the inertia force is applied.

5. The door outer handle device according to claim 3, wherein the lever member includes a first engagement portion and a second engagement portion, the first engagement portion engaging with a portion of the outer handle in the door closed position and restricting the lever member from rotating by the biasing member in a case where the lever member is arranged at the set rotation position, the second engagement portion engaging with the base member and restricting the lever member from rotating by the biasing member in a case where the lever member is arranged at the retracted rotation position.

6. The door outer handle device according to claim 5, wherein the outer handle includes a third engagement portion engaging with the link mechanism and selectively engaging with the first engagement portion.

7. The door outer handle device according to claim 5, wherein the base member includes a stopper portion selectively engaging with the second engagement portion.

8. The door outer handle device according to claim 3, wherein the door opening prevention mechanism includes a holding mechanism to hold the lever member at the locked rotation position.

9. The door outer handle device according to claim 8, wherein the holding mechanism includes a shoe portion engaging with the base member in a direction from the locked rotation position to the set rotation position of the lever member, wherein the lever member includes a shaft portion assembled on the base member to be rotatable and movable in an axial direction of the lever member, and wherein the biasing member biases the lever member in the axial direction so that the shoe portion engages with the base member.

10. The door outer handle device according to claim 8, wherein the link mechanism includes a return mechanism automatically returning the outer handle from the door open position to the door closed position and a lock release mechanism releasing the lever member, which is held at the locked rotation position by the holding mechanism in association with a return operation by the return mechanism, from the locked rotation position.
